(19) United States
(12) Patent Application Publication
(10) Pub. No.: US 2016/0086706 A1
(43) Pub. Date: Mar. 24, 2016

(54) AMORPHOUS ALLOY TRANSFORMER IRON CORE OF THREE-DIMENSIONAL TRIANGLE STRUCTURE

(71) Applicants: Kaixuan Xu, Kaiping City (CN); Xianqing Guo, Kaiping City (CN)

(72) Inventors: Kaixuan Xu, Kaiping City (CN); Xianqing Guo, Kaiping City (CN)

(21) Appl. No.: 14/372,634

(22) PCT Filed: Jun. 7, 2012
(86) PCT No.: PCT/CN2012/076604

§ 371 Date: Dec. 13, 2015

(30) Foreign Application Priority Data
May 28, 2012 (CN) 20121067698.7

(51) Int. Cl. H01F 3/04; H01F 27/26

(52) U.S. Cl. CPC H01F 3/04; H01F 27/263

(57) ABSTRACT

An amorphous alloy transformer iron core of a three-dimensional triangle structure belongs to the technical field of electrical devices. The amorphous alloy transformer iron core of the three-dimensional triangle structure is formed by piecing three identical rectangular single frames whose sections are approximately semicircular. A manufacturing method thereof comprises steps of cutting, winding, assembling, annealing and molding. The amorphous alloy transformer iron core of the three-dimensional triangle structure has the advantages of saving materials, reducing loss and noise, balancing three phases, enabling coils not to be sleeved, and being stable in performance and strong in anti-short circuit capacity.

### FIELD OF THE INVENTION

This invention relates to a triangular amorphous alloy 3D core transformer, especially the manufacturing method of its core.

### BACKGROUND OF THE INVENTION

Energy saving is an essential national policy of China to construct a conservation-oriented society. Due to the remarkable ability of amorphous alloy transformer to save energy and protect the environment, it has been gradually accepted by the majority of users and becomes an ideal new generation of distribution transformer. Currently, three-phase five-limb planar wound core and three-phase three-limb planar wound core are applied in amorphous alloy transformer on the market. The cross section of these two kinds of planar amorphous alloy cores for transformer is rectangle. It has disadvantages like huger size of core, heavier overall weight, and longer processing time. Additionally, the size design of transformer is prone to be restricted by amorphous alloy sheet width. The design and manufacture are inflexible. The cost of the amorphous alloy core above is higher.

Theoretically, both three-phase five-limb and three-phase three-limb are in planar structure, in which the lengths of magnetic circuits are unequal. Consequently, three-phase electric power distribution may be not symmetrical. Additionally, lots of seams on the upper or lower yoke may form an area of high energy consumption. Thus, it could not take full advantage of the strong magnetic conductibility of the amorphous alloy. And the air gaps in the seams may increase corresponding loss. The rectangular core and coil of transformer may lead to the weak ability to withstand short-circuit of the product.

### SUMMARY OF THE INVENTION

This invention is to present a triangular amorphous alloy 3D core for transformer whose cost is lower than the traditional one and performance is optimal.

This invention is realized by a triangular amorphous alloy 3D core for transformer made of three identical rectangle frames with approximate semicircular cross section, wherein its manufacturing method is comprised by following steps:

(1) Slitting

Slit the rectangular amorphous alloy strips in fixed width into trapezoid strips;

(2) Winding

Rectangular mould as inner support, starting from the first stage winding of the single frame, trapezoid strip is wound layer by layer from inside out, and then make trapezoid strips in the winding machine follow the given direction, as a result, its upper and lower parts are outwardly inclined;

After completion of the required thickness of the first stage winding, at the second stage, strip in another size is wound on outer layer of the first stage winding, and then other required thickness of the winding is consecutively achieved in the same way;

(3) Assembling

A whole amorphous alloy core is made of three identical single frames (FIG. 3), because the cross section of two limbs of every single frame is approximate semicircular, after combination and fixation of the limbs of three single frames, the circular core limb is constituted;

(4) Annealing

The annealing of the assembled triangular 3D core is finished in annealing oven in order to relieve the internal stress, recover the magnetism, and further improve the performance of core;

(5) Molding

Tie the combined core limbs with insulation banding tape after aligning of the core to make the core to be a firm entirety.

The characteristic of the triangular amorphous alloy 3D core for transformer is that the cross section of the rectangular single frame is approximately semicircular.

This invention relates to a triangular amorphous alloy 3D core for transformer. In structure, triangular amorphous alloy 3D core for transformer is made of three identical single frames with approximate semicircular cross section through special technique after combination of them. The cross sections of the three core limbs are approximate circular. And every single frame is wound with several sizes of amorphous alloy trapezoid strips consecutively and tightly to form a semicircular cross section. Compared with the traditional amorphous alloy core, the yoke of triangular amorphous alloy 3D core is more than 20% lighter, and its angle parts are lighter. Consequently, the consumption of amorphous alloy is greatly diminished. Moreover, there is no seam in the yoke of triangular amorphous alloy 3D core. Therefore, there is no need to open the yoke and then close it, and the coil of transformer could be wound directly around the core limbs. Consequently, the processing time is shorter and efficiency of labor is raised.

In performance, magnetic conduction direction of the amorphous alloy strips is exactly the same with the magnetic circuit direction of the core, which greatly minimizes vibration and solves the problem of noise in traditional amorphous alloy. Moreover, the three-phase magnetic circuit of core is completely symmetrical and of equal length. Consequently, three-phase electric power distribution is able to be symmetrical and magnetic reluctance and magnetizing current are significantly reduced. Besides, there is no seam in the yoke of triangular amorphous alloy 3D core for transformer, so there is no high energy consumption area. Thus, it could take full advantage of the strong magnetic conductibility of the amorphous alloy and loss resulted from the air gaps in seam is minimized. Furthermore, there is a sharp decline in no-load loss of the triangular amorphous alloy 3D core for transformer because no-load loss is directly proportional to the weight of core. Additionally, the cross section of three core limbs in this kind of amorphous alloy transformer is approximate circular, and the coil is approximate circular as well. The combination of them enormously improves the ability of the amorphous alloy 3D core transformer to withstand short circuit.

### BRIEF DESCRIPTION OF THE DRAWINGS

FIG. 1 is front view of the trapezoid strip of this invention.

FIG. 2 is the winding of single frame of this invention.

FIG. 3 is front view of the single frame of this invention.

FIG. 4 is A-A section view of FIG. 3.

FIG. 5 is 3D view of the single frame of this invention.

FIG. 6 is vertical view of single frame before combination of this invention.

FIG. 7 is vertical view of amorphous alloy 3D core of this invention.

FIG. 8 is 3D view of amorphous alloy 3D core of this invention.

### DETAILED DESCRIPTION

A full and enabling discourse of this invention, integrating the appended figures, is set forth in the specification, in which:

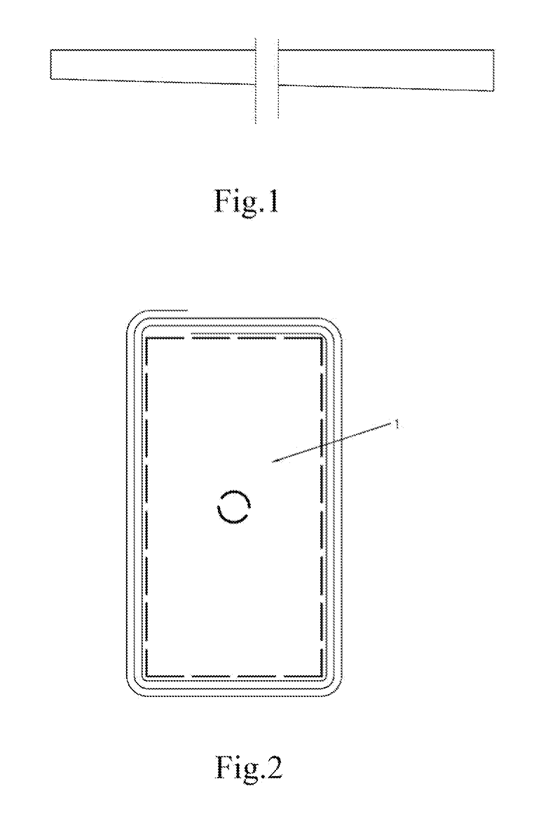

Showing in FIG. 1, a triangular amorphous alloy 3D core for transformer is made of three identical rectangle frames with approximate semicircular cross section,

Wherein its manufacturing method is comprised by following steps:

(1) Slitting

The thickness of amorphous alloy material is usually 0.025 mm. Slit the rectangular amorphous alloy strips in fixed width into several sizes of trapezoid strips in the shape showing in FIG. 1.

(2) Winding

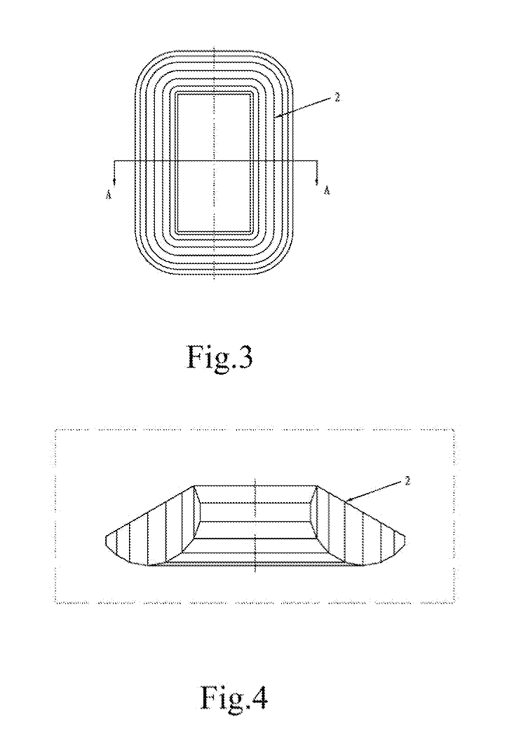

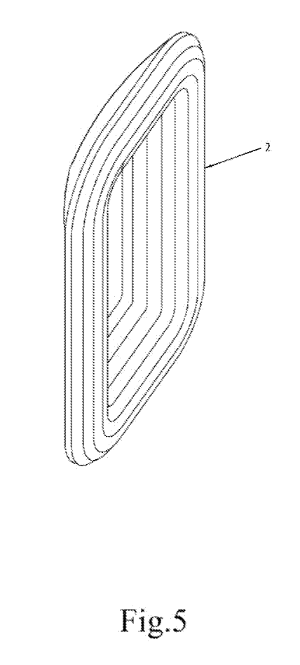

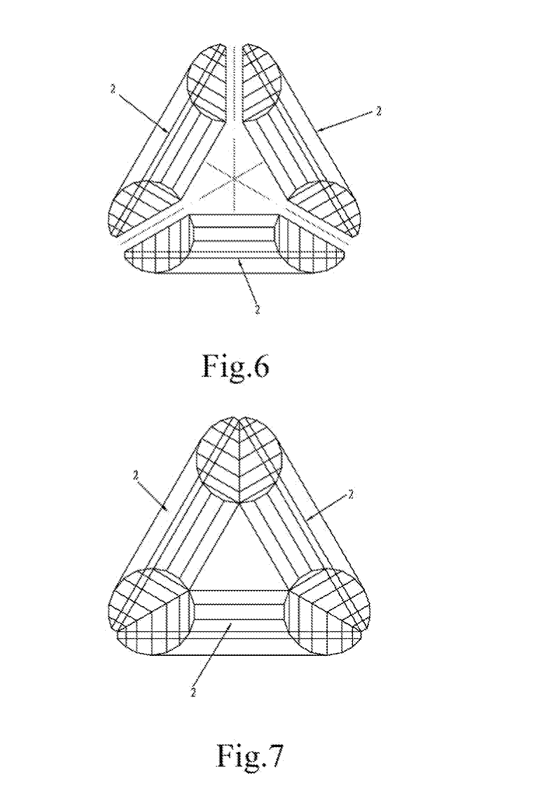

Rectangular mould 1, showing in FIG. 2, as inner support, starting from the first stage winding of the single frame, trapezoid strip is wound layer by layer from the inside out and make trapezoid strips in the winding machine follow the given direction, as a result, its upper and lower parts are outwardly inclined; after completion of the required thickness of the first stage winding, at the second stage, strip in another size is wound on outer layer of the first stage winding, and then other required thickness of the winding is consecutively achieved in the same way; if it is a seven-stage single frame, then seven sizes of trapezoid strips are required, in addition, the width of the head of latter strip is the same as that of the end of the former and the thickness of each stage winding may not be the same; FIG. 3 is front view of finished single frame; FIG. 4 is section view of cross section of single frame; FIG. 5 is side view of single frame.

(3) Assembling

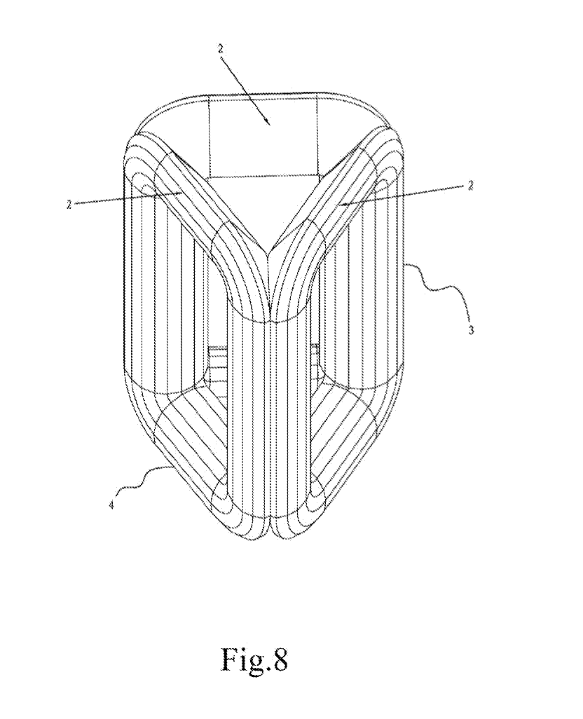

A whole amorphous alloy core is made of three identical single frames 2, showing in FIG. 3, and the cross section of two limbs of every single frame 2 is approximate semicircular, which constitutes the approximate circular core limb 3 after combination and fixation of the limbs of three single frames 2; FIG. 7 is vertical view of combined triangular amorphous alloy 3D core; in FIG. 8, 2 indicates upper yoke and 4 indicates lower yoke.

(4) Annealing

The annealing of the assembled triangular 3D core is finished in annealing oven in order to relieve the internal stress, recover the magnetism, and further improve the performance of core.

(5) Molding

Tie the combined core limbs with insulation banding tape after aligning of the core to make the core to be a firm entirety, shown in FIG. 8.

FIG. 8 is 3D view of finished triangular amorphous alloy 3D core for transformer. As FIG. 8 illustrates, three single frames form the three core limb, which are in the structure of triangular prism. And the cross sections of core limbs are approximate circular.

The thickness of amorphous alloy material is usually 0.025 mm. It is hard and brittle. This invention adopts special technique, instrument, and equipment in order to overcome the difficulties in slitting amorphous alloy material and manufacture of amorphous alloy 3D core.

The embodiment described above is just the prior one. It should be noticed that for general technical staff in this field, several improvement and modification may be made without departing from the principles of the case, which are also considered as the protection scope of the invention.

1. (canceled)

2. (canceled)

3. An amorphous alloy triangular 3D core for transformer made of three identical rectangle frames with an approximately semicircular cross section, manufactured by a process comprising the steps of:
(a) slitting rectangular amorphous alloy strips in fixed width into trapezoid strips; winding about
(b) winding, so as to provide a rectangular mould as inner support, starting from the first stage winding of the single frame, trapezoid strip that is wound layer by layer from inside out and wherein each trapezoid strip in the winding machine follows the predetermined direction, so that each of the upper and lower parts are outwardly inclined;
after completion of a required thickness of the first stage winding, at a second stage, strip in another size is wound on outer layer of the first stage winding, and then other required thickness of the winding is consecutively achieved in the same way; the width of the head of latter strip is the same as that of the end of the former;
(c) assembling, so as to provide a whole amorphous alloy core constructed from three identical single frames, wherein the cross section of two limbs of each single frame is approximately semicircular, after combination and fixation of the limbs of each of three single frames, the circular core limb is constituted;
(d) annealing the assembled triangular 3D in order to relieve internal stress thereof, recover magnetism thereof, and further improve performance thereof;
(e) moulding the combined core limbs with insulation banding tape after aligning of the core to produce firmness in the core.

4. The amorphous alloy triangular 3D core of claim 3, wherein the cross section of the rectangular single frame is approximately semicircular.
